(19) United States
(12) Patent Application Publication
(10) Pub. No.: US 2012/0114246 A1
(43) Pub. Date: May 10, 2012

(54) ENHANCED GRAPHOLOGICAL ASSESSMENT OF PERSONALITY USING CATEGORIZATION OF HANDWRITING FEATURES TO INDICATE RELATIVE LEVEL OF INHERENCY AND HABITUALNESS OF PERSONALITY TRAITS THAT ARE ASSOCIATED WITH THE HANDWRITING FEATURES

(76) Inventor: Michael Scott Weitzman, West Islip, NY (US)

(21) Appl. No.: 12/943,320

(22) Filed: Nov. 10, 2010

(51) Int. Cl. G06K 9/00

(52) U.S. Cl. 382/187

(57) ABSTRACT

A method for personality assessment through analysis of handwriting is disclosed that provides a way to take into account the relative influence of personality traits indicated by different handwriting features, depending upon the type of handwriting features, and how strongly those features are expressed. The method improves the assessment of personality through handwriting analysis, by separating handwriting features into categories that highlight which aspects of the subject's personality are inherent and deeply-rooted versus changeable and superficial; as well as which aspects of the subject's personality are habitually expressed, versus non-habitually expressed. Handwriting features are separated into primary variables that represent more inherent aspects of the subject's personality, and secondary variables that represent less inherent aspects of the subject's personality. Handwriting features are also separated into dominant variables that represent habitually expressed aspects of the subject's personality, and non-dominant variables that represent non-habitually expressed aspects of the subject's personality.

### FIELD

This invention relates to graphology, and more particularly to graphological assessment of personality traits.

### BACKGROUND

Graphology is the study and analysis of an individual's handwriting. Graphology, sometimes simply called handwriting analysis, typically has been used to identify or certify an individual's handwriting, for example to verify a signature and/or to validate evidence. Graphology can also be used in evaluating an individual's personality. This use of graphology tends to be more accepted in Europe than in the U.S., but may be gaining more acceptance in the U.S.

The variables analyzed in graphology are those features of handwriting that can vary within an individual's handwriting, as well as between the handwriting from different individuals. The variables include the use of space, the size of the handwriting, zonal sizes in the writing, letter slant, connective forms, pressure applied in writing, print versus script, specific letter formations, and form level of the writing. More than one hundred features of handwriting have been identified and classified as variables for use in handwriting analysis.

As commonly used, graphology assigns meaning to particular features or sets of features that appear in an individual's handwriting. While the large number of handwriting features can provide a wealth of information about an individual's handwriting, problems can arise due to various handwriting features seeming to offer conflicting information about the individual.

Although graphology may place more emphasis on some handwriting features than on others, such placement of emphasis is often applied arbitrarily. Therefore, some handwriting features may be favored over others simply for the sake of eliminating contradictions, with little to no justification for the decisions made.

### SUMMARY

A method for personality assessment through analysis of handwriting is claimed that provides a way to take into account the relative influence of personality traits indicated by different handwriting features, depending upon what type of handwriting features they are, and how strongly those features are expressed. For example, some handwriting features may overshadow or contradict other features, reinforce or complement other features, be given a different level of importance relative to other features, and/or indicate a different level of meaning or insight in light of the other features.

The method improves the assessment of personality through handwriting analysis, by separating handwriting features into categories that highlight which aspects of the subject's personality are inherent and deeply-rooted versus changeable and superficial; as well as which aspects of the subject's personality are habitually expressed, versus expressed relatively inconsistently.

### BRIEF DESCRIPTION OF THE DRAWINGS

FIG. 1 is a perspective view of a person producing a handwriting sample while writing on a writing pad, the writing sample capable of being used for personality assessment according to an exemplary embodiment of the present invention;

FIG. 2A is a diagram showing all handwriting variables of the handwriting sample of the subject depicted in FIG. 1, being categorized into primary variables which are representative of an individual's more deeply-rooted personality traits, and secondary variables which are representative of a subject's less deeply-rooted personality traits;

FIG. 2B is a diagram showing all handwriting variables of the handwriting sample of the subject depicted in FIG. 1, being categorized into dominant variables which are representative of an individual's dominant traits, and non-dominant variables which are representative of a subject's non-dominant personality traits;

FIG. 2C is a diagram showing all handwriting variables of the handwriting sample of the subject depicted in FIG. 1, being categorized into dominant primary variables, non-dominant primary variables, dominant secondary variables, and non-dominant secondary variables;

FIG. 3 is a graph depicting the relative levels of inherency and habitual expression for the categorized variables shown and discussed in connection with FIG. 2C;

FIG. 4A is a list of sample of handwriting features that are categorized as primary variables, and the personality traits that they are typically associated with by graphologists;

FIG. 4B is a list of sample of handwriting features that are categorized as secondary variables, and the personality traits that they are typically associated with by graphologists;

FIG. 5 is a chart depicting handwriting features that are assessed to determine a subject's overall handwriting form level, which can impact how other aspects of the subject's handwriting are interpreted;

FIG. 6 is a handwriting sample produced by a subject for analysis of the subject's personality in accordance with an embodiment of the invention;

FIG. 7 is an example graphological personality assessment Conclusions section, which summarizes conclusions made in accordance with an embodiment of the invention; and

FIG. 8 is a flowchart detailing the steps taken by a graphologist in assessing a subject's personality in accordance with an embodiment of the invention.

### DETAILED DESCRIPTION

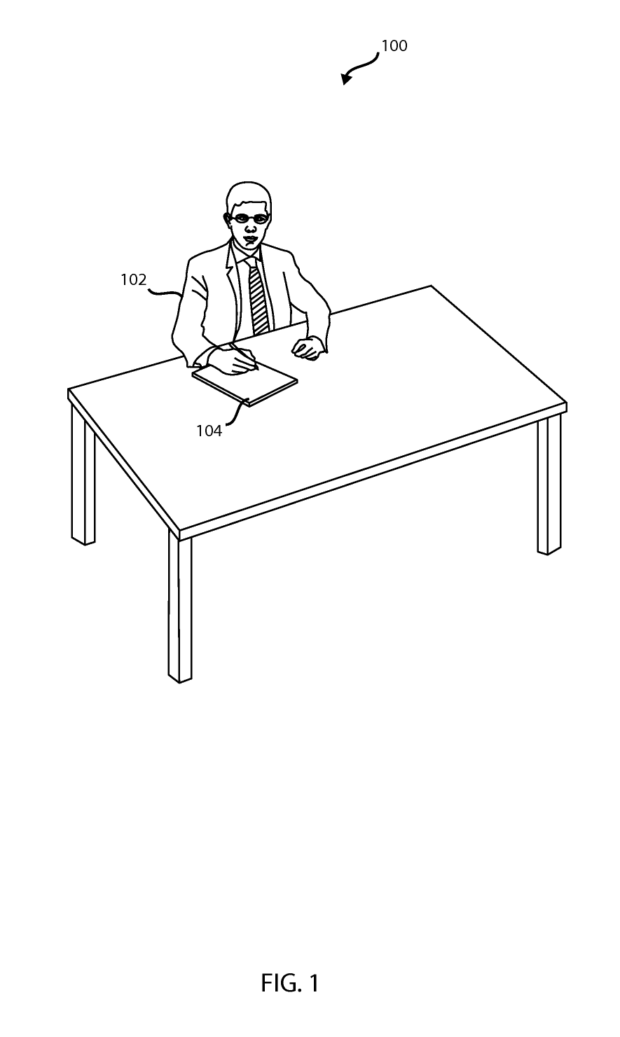

FIG. 1 is a perspective view of a subject producing a handwriting sample while writing on a writing pad, the writing sample capable of being used for personality assessment according to an exemplary embodiment of the present invention. Any sample of a subject's genuine handwriting can be sufficient for the purposes of personality assessment of the subject based on the subject's handwriting.

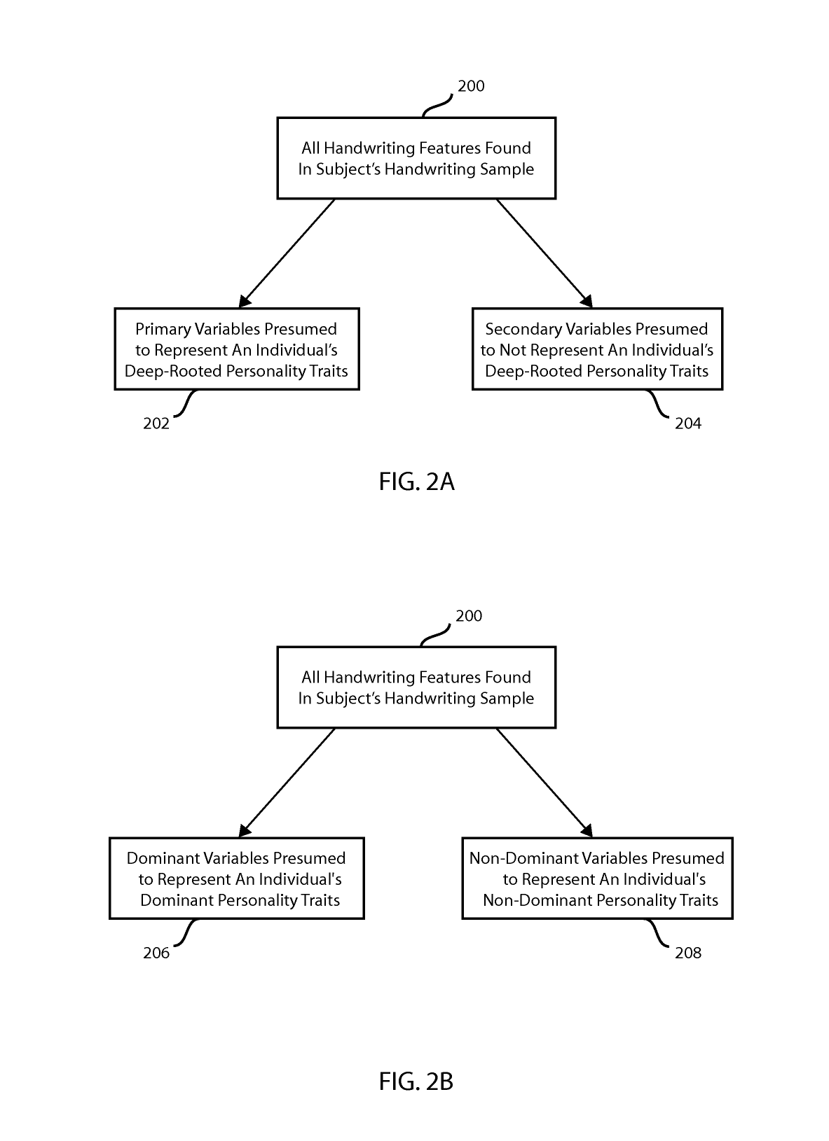

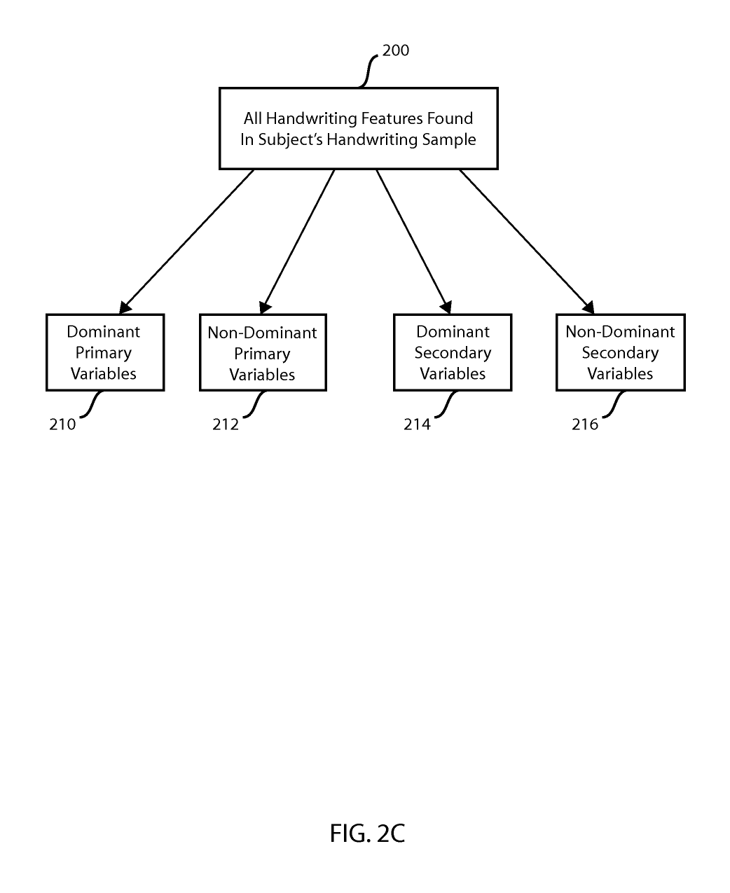

FIG. 2A is a diagram showing all handwriting variables of the handwriting sample of the subject depicted in FIG. 1, being categorized into primary variables which are representative of an individual's more deeply-rooted personality traits, and secondary variables which are representative of a subject's less deeply-rooted personality traits. In some embodiments, secondary variables represent aspects of the subject's personality that are changeable.

The key distinction to make between primary and secondary variables is that primary variables are handwriting features that are categorically presumed to represent aspects of an individual that are more deeply-rooted than other aspects of the individual's personality. Absent traumatic or other life-changing events, these deep-rooted aspects of their personality are not likely to change, because they are inherent to the person.

FIG. 2B is a diagram showing all handwriting variables of the handwriting sample of the subject depicted in FIG. 1, being categorized into dominant variables which are representative of an individual's dominant personality traits, and non-dominant variables which are representative of a subject's non-dominant personality traits.

Any handwriting feature that is expressed strongly in a subject's handwriting is a dominant variable, interpreted as being a dominant variable.

A dominant variable designated as representing an aspect of the subject's personality that is expressed more habitually and consistently than other aspects of their personality. In some embodiments, non-dominant variables are designated as representing aspects of the subject's personality that are expressed less consistently than aspects of the subject's personality represented by dominant variables.

FIG. 2C is a diagram showing all handwriting variables of the handwriting sample of the subject depicted in FIG. 1, being categorized into dominant primary variables, non-dominant primary variables, dominant secondary variables, and non-dominant secondary variables. A primary variable or secondary variable is a dominant variable if it is expressed strongly in a subject's handwriting. If it is not expressed strongly in the subject's handwriting, then the primary or secondary variable is a non-dominant primary or secondary variable.

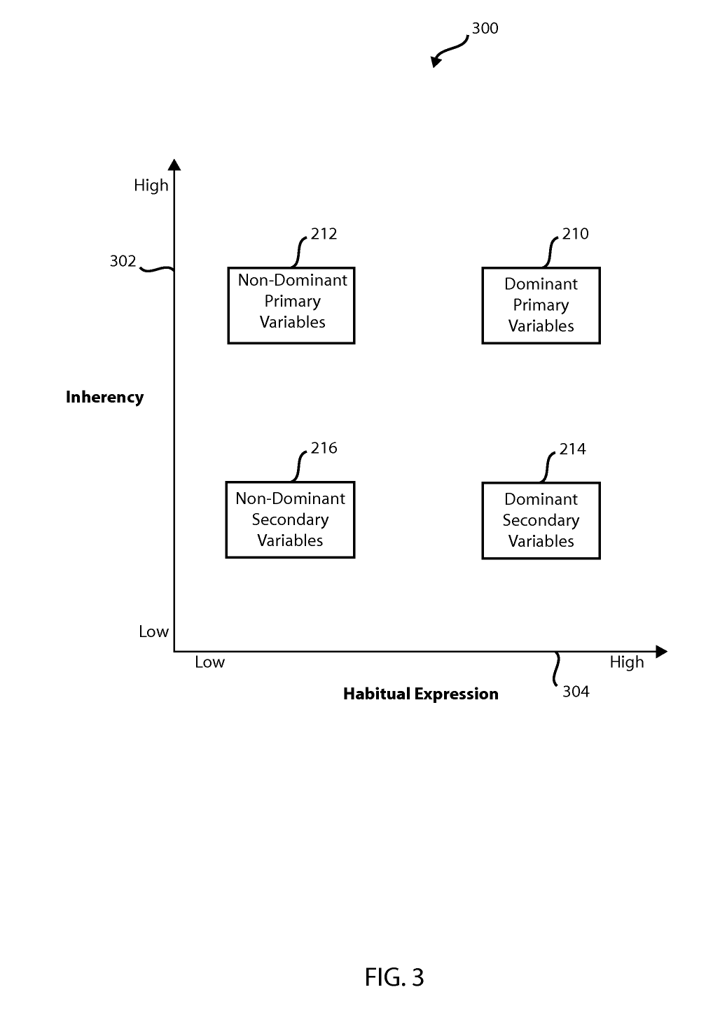

FIG. 3 is a graph depicting the relative levels of inherency and habitual expression for the categorized variables shown and discussed in connection with FIG. 2C. As shown in the figure, primary variables of all types are designated as representing more inherent aspects of a subject's personality, than are secondary variables. Furthermore, dominant variables of all types are designated as representing more habitually expressed aspects of the subject's personality, than non-dominant variables.

Therefore, dominant primary variables represent aspects of a subject's more inherent and more habitually expressed personality. Non-dominant primary variables represent aspects of the subject's more inherent, but less habitually expressed, personality. Dominant secondary variables represent aspects of the subject's more habitually expressed, but less inherent, personality. And finally, non-dominant secondary variables represent aspects of the subject's less inherent and less habitually expressed personality.

Graphology, or the study of handwriting, is carried out in terms of particular features exhibited in the handwriting. There are hundreds of features that have been defined and used in the analysis of handwriting. The following tables include some of the most prominent features utilized in embodiments of the present invention. It is understood that additional features, as known in the art, can readily be included without departing from the scope of this disclosure.

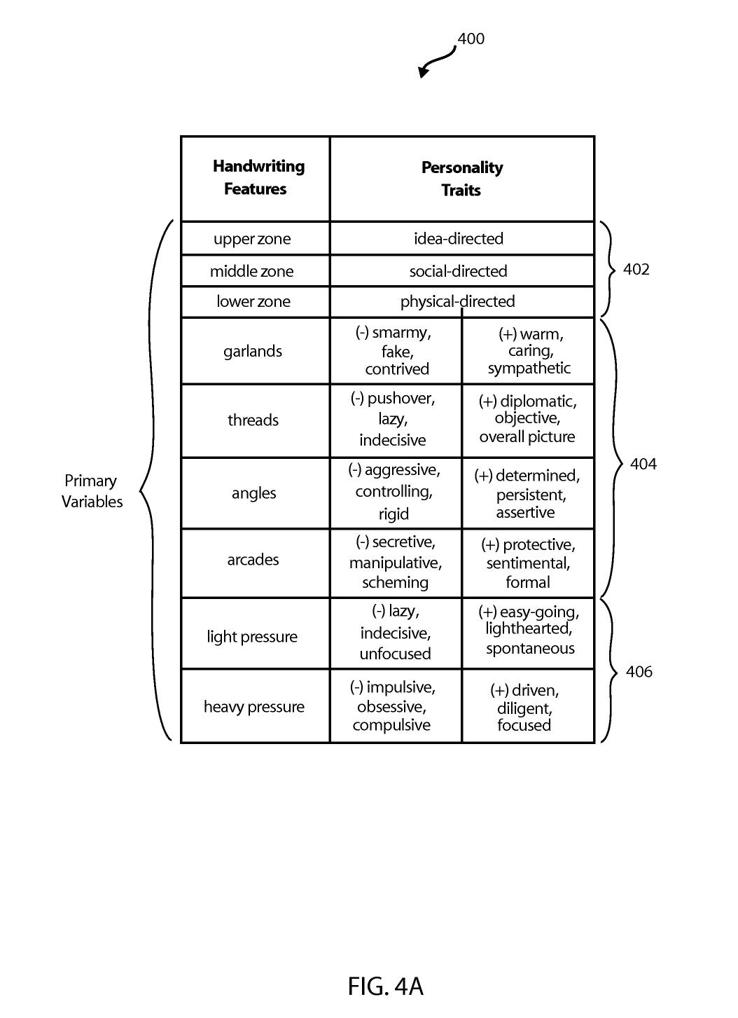

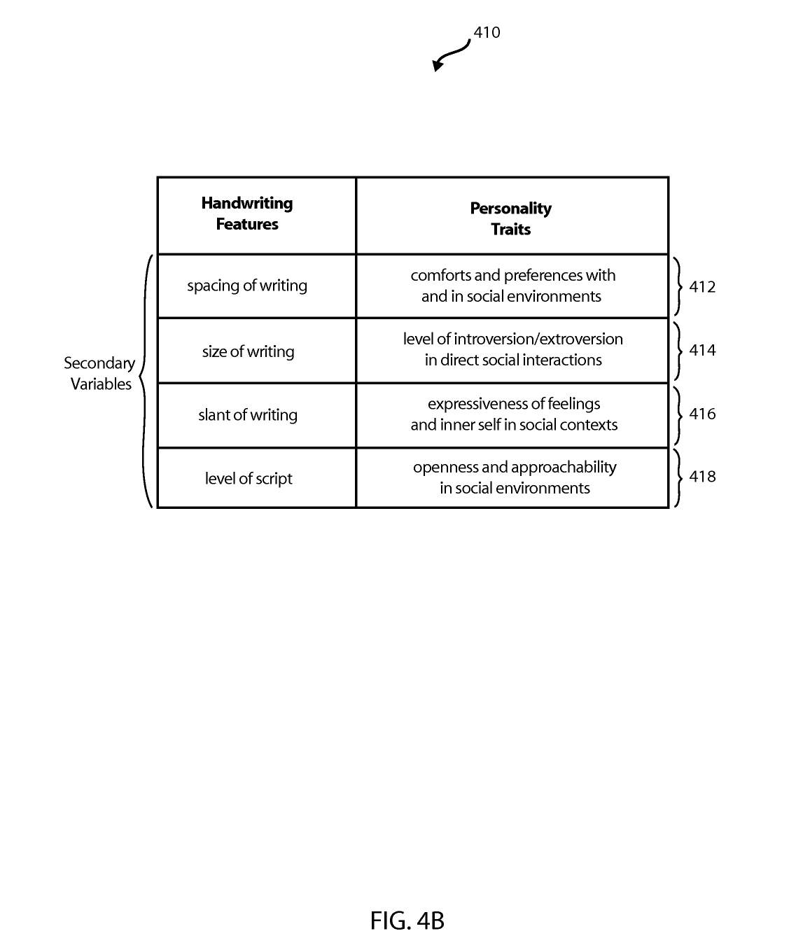

FIG. 4A is a list of sample of handwriting features that are categorized as primary variables, and the personality traits that they are typically associated with by graphologists. The top three handwriting features 402 are zonal size features of handwriting, the following four handwriting features 404 are connective forms, which are handwriting features occurring in the connection of one letter to an adjacent letter, and the last two handwriting features 406 relate to handwriting pressure.

The zones 402 represent the size of certain zones of letters relative to the size of the rest of the letter, and in particular: the size of the upper, middle, and lower zone of a letter relative to the entire letter. These zones relate to the upper, middle, or lower third of the extended space that a letter potentially fills, respectively. A size of 3 mm for each of the individual zones is generally taken as the standard, with an overall 9 mm as the standard of size for handwriting. As known to those skilled in the art, the upper zone is that portion of the handwriting that includes the upper portions of the tall letters with “extender” portions that extend vertically, such as the letters b, d, f, h, k, l, and t. The lower zone includes the lower portions of letters with “descenders,” such as the letters f, g, j, p, q, y, and z. The middle zone includes the middle portions of extended letters, or in their entirety letters which do not extend up or down, such as, for example, a, e, r, m and c. It will be appreciated that the invention is not limited to handwritten English, and that the methods of handwriting analysis for personality assessment as described herein can also be applied to other languages, for example, French and Spanish (both of which use a cedilla), Greek, and non-Western languages. The zones 402 provide information regarding the focus of a subject's inner thoughts and their inner needs, desires, hopes and dreams. Any given zone (upper, middle, or lower) of the letters of a subject's handwriting can be “undeveloped,” or “developed.” Zones can be expressed dominantly as well. The upper zone relates to a subject's thoughts and their inner mental world. The middle zone relates to a subject's social world, the here and now, and the fitting in with trends and people. The lower zone relates to carnal energy, physical and body energy, and subconscious and unconscious drive. Someone with a developed zone is involved in the respective sphere of existence associated with that zone, whereas someone with an undeveloped zone is less than fully involved in the dimension of life related to that zone. A dominant zone indicates a habitual and consistent connection to the dimension of life corresponding to that zone. The connective forms 404 are indicative of how a subject relates to people, and how the subject expresses themselves in relation to pursuing their goals. The connective forms 404 that are listed are garlands, threads, angles, and arcades. Garlands are connective forms that are curved at the bottom and open at the top, like a cup, for example. Arcades, in contrast, are connective forms that are curved on top and open at the bottom, like an arch. Angles include abrupt changes in direction. Threads are squiggle-shaped connective forms that look like a mixture of garlands and arcades. Threads can sometimes be sinuous, thinning, or diminishing, which can lead them to be interpreted more negatively in certain contexts.

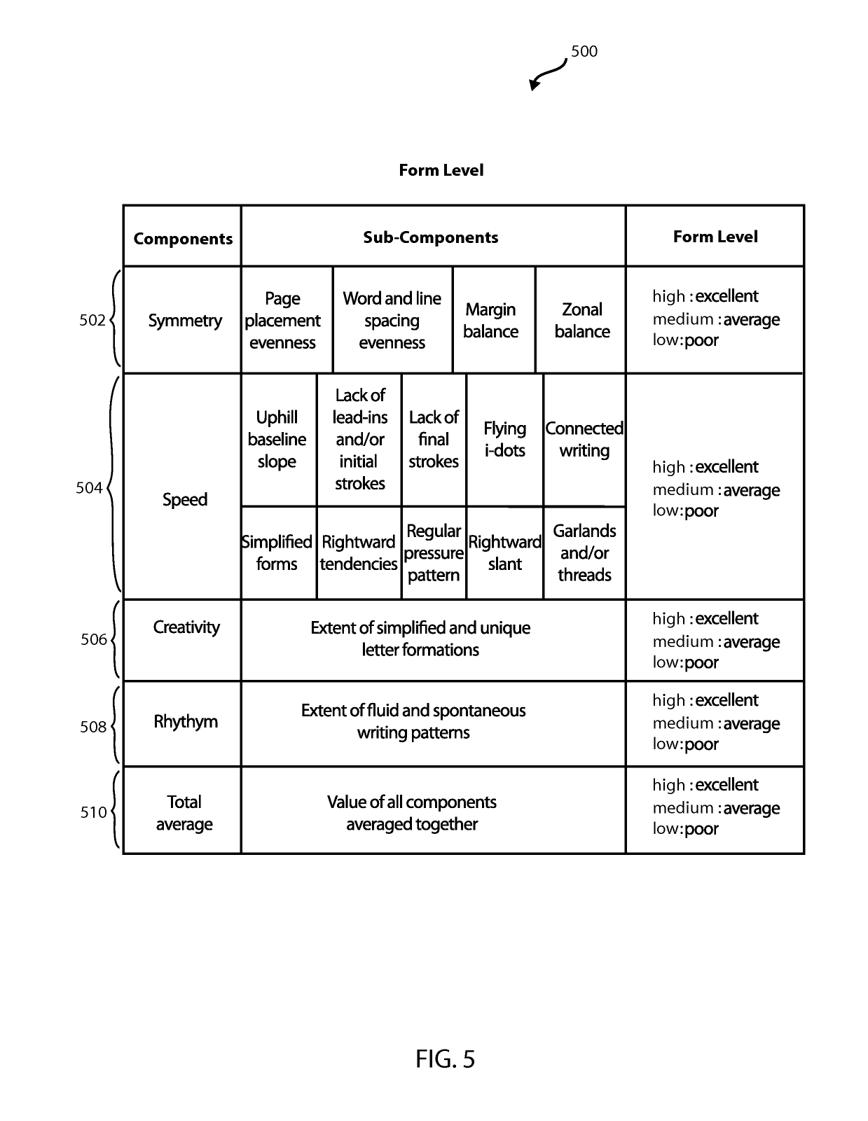

Connective forms can be interpreted in either a positive light or negative light, depending upon the overall “form level” of a subject's handwriting (form level is discussed further below, in connection with FIG. 5). Garlands indicate warmth, caring, and a sympathetic disposition if interpreted positively, but interpreted negatively they can indicate that a subject is smarmy, fake or contrived. Threads can indicate someone who is diplomatic, skilled at negotiation and objectively seeing the big picture in situations, or interpreted negatively they can indicate a pushover or someone who is lazy or indecisive. Angles can indicate someone who is determined, persistent and assertive, or if interpreted negatively, someone who is overly aggressive, controlling or rigid. Arcades can indicate someone who is protective, sentimental, and/or formally courteous in their disposition, or if interpreted negatively, secretive, manipulative and/or scheming. Pressure in handwriting 406 can be indicative of how driven or easygoing a person is. A person can have light pressure or heavy pressure (or a level of pressure that lies in between those extremes). Level of pressure 310 affects line width, so a measure of applied pressure is the line width of a pen trace, for example, in number of pixels for scanned handwriting, or carefully measured under magnification in the case of manual processing. In conventional graphology, strong applied pressure may suggest a healthy driving force, a diligence, and/or a strong focus indicating commitment and seriousness, but when interpreted negatively, can indicate impulsiveness, obsession, and/or compulsiveness. Light pressure, on the other hand, can show sensitivity, empathy, and an easygoing, light-hearted, spontaneous and resilient posture if interpreted positively, but can indicate laziness, indecisiveness, or lack of focus if interpreted negatively.

FIG. 4B is a list 410 of sample of handwriting features that are categorized as secondary variables, and the personality traits that they are typically associated with by graphologists. The top secondary variable 412 is the handwriting feature of spacing of handwriting, followed by size of handwriting 414, followed by slant of handwriting 416, which is followed by the final handwriting feature listed at the bottom of the chart, which is level of script 418. As secondary variables, these handwriting features are indicative of less inherent or deep-rooted aspects of a subject's personality, and therefore these aspects of personality are typically more prone to change, than are the aspects of personality indicated by primary variables.

The use of space 412 can refer to the space between words, as well as between letters. The standard for the use of space between words is the width of one handwritten letter (as written by the subject). Spaces between letters in a word may be of note, particularly if the writing of that word is cramped or expanded compared with the other words in the handwriting. Often the spacing between lines is included in the analysis of handwriting, particularly the sample was written on unlined paper.

The next secondary variable is the handwriting feature of size 414 of a subject's handwriting. The size 414 of a subject's handwriting indicates their direct and indirect behavior, and their level of introversion or extroversion in direct social interactions. Larger overall size indicates more outgoing behavior, and more relating around people and between people, while smaller size indicates a more reserved and shy nature, and less relating to others.

The next secondary variable listed is the handwriting feature of the slant 416 of the handwriting. The slant can indicate the extent to which a subject is expressive of their feelings and their inner self in social contexts. A rightward slant indicates more social expression of self, whereas a leftward slant can indicate a more socially introverted mode of expressiveness of self and emotions, such as artistic expression.

Finally, the final secondary variable listed is the handwriting feature of the level of script 418 of a subject's handwriting. Whether the handwriting is printed or written in script can indicate significant differences in a subject's willingness to be open and approachable socially. Graphologists often read the level of cursive of a person's handwriting to be a helpful gauge in assessing whether the person is approachable, versus less socially penetrable, or stoic.

All of these handwriting features of spacing, size, slant, and script, are deemed secondary variables according to an embodiment of the invention, and therefore are categorically presumed to point to less deeply-rooted personality traits of a subject, than traits indicated by primary variables (discussed above in connection with FIG. 4A). These traits are therefore to be considered less representative of the subject's inherent personality, than traits indicated by primary variables. Furthermore, at the same time it should be remembered that traits expressed dominantly (whether they are primary variables or secondary variables), are deemed to indicate a subject's dominant personality traits, and are therefore taken to indicate more habitually expressed aspects of the subject's personality, than non-dominant traits indicated by non-dominant variables.

FIG. 5 is a chart 500 depicting handwriting features that are assessed to determine a subject's overall handwriting form level, which can impact how other aspects of the subject's handwriting are interpreted. The form level of the handwriting can be defined, informally, as an overall impression given by the handwriting. In some embodiments, applying a form level analysis can provide an indication of the social healthiness of a subject's personality, thereby enhancing interpretation of the subject's handwriting features so as to aid in determining the subject's personality traits.

Form level includes how the writing flows, that is, whether the handwriting seems fluid or broken. Form level can also include other attributes such as overall legibility, symmetry 502, speed 504, creativity 506, and even rhythm 508 of the handwriting. In conventional graphology, high form level represents a high overall impression of the handwriting, while low form designates an overall low form of the handwriting. It will be appreciated that form level can also be applied to the overall impression of an individual handwritten word.

Form level has four main components, the first one of which is symmetry 502. Symmetry 502 sheds light on a subject's internal organization, represented by the evenness and balance in their handwriting. The subject's personality as interpreted by other variables, will be interpreted through the lens of their form level.

In the case of the form level component of symmetry, this is done by deducing from the symmetry score, whether they are mentally organized and methodical towards their goals, whether they have psychological and emotional balance, and how they cope with stress, and whether there is consistency in their psychological and emotional behavior.

Symmetry 502 can be given a score based on such factors as: the evenness of the subject's placement of their writing on a page; the evenness of their word (and/or letter), and/or line spacing; their margin balance; and the balance of their zones.

The second main component of form level is speed 504, which sheds light on a subject's ability to process information. This can be helpful in indicating whether a subject can employ on-the-spot thinking, and can process information efficiently and productively.

Speed 504 can be given a score based on such factors as: the slope of their writing; presence or lack of lead-ins or long initial strokes at word beginnings; presence or lack of final strokes at word endings; connectedness of writing; simplified form of writing; pressure pattern; slant; and presence or lack of garlands and/or threads.

The third main component of form level is creativity 506, which sheds light on a subject's leadership quality, and their uniqueness and efficiency of thought and character. A subject with a high creativity score, for example, is deemed to be thinking based truly on an efficient, unique, innovative and completely objective thought process, rather than being unduly influenced by societal norms.

Creativity 506 also indicates an ability to “break from the mold” in an efficient and productive way, to rise above outdated ways of doing things, and to see more beneficial solutions to dilemmas. Therefore, creativity is assessed by observing the extent to which letter formations are uniquely crafted in a simplified way. This indicates the subject has crafted their own unique way of writing efficiently, having moved beyond the precise rules of writing and letter formation to a new system of letter formations that is more efficient for them.

The fourth and last main component of form level is rhythm 508, which indicates a subject's ability to accomplish tasks in an efficient manner. In contrast to a rigid affect, a subject with high form level in the rhythm category will have a certain fluency and economy in their approach to problems and to life. Rhythm 506 is indicated by expansive handwriting, consistent pressure, a bouncy flow to the writing, and fluid and spontaneous writing patterns.

These four main components 502, 504, 506, 508 can then be averaged together to obtain an average overall form level 510. An individual's form level will typically stay with them into adulthood, except if and when faced with significant or somewhat life-changing events or challenges.

Someone with excellent form level may be more efficient than one with average form level, but they may be vulnerable. If a big tragedy strikes, an untested individual with high form level regress into poor form level. But if they work themselves through the problem, they've learned resilience and they'll probably stay there with a new strength and solidity.

The person with a stable equilibrium of high form level would be considered to have resilient high form level. Someone with high form level who is susceptible to falling apart in the face of large challenges they have yet to face, would be considered to be in a state of dynamic equilibrium and therefore non-resilient form level. Resilience and stability is another important aspect of assessing form.

The individual with resilient high form level is deemed to be closer to being a self-actualized person, not likely to be compromised or to regress. High form level leads to other handwriting features (such as primary and secondary features, dominant and non-dominant features) to be interpreted in a more positive light, rather than being viewed through a more negative lens, as in the case of someone with poor form level.

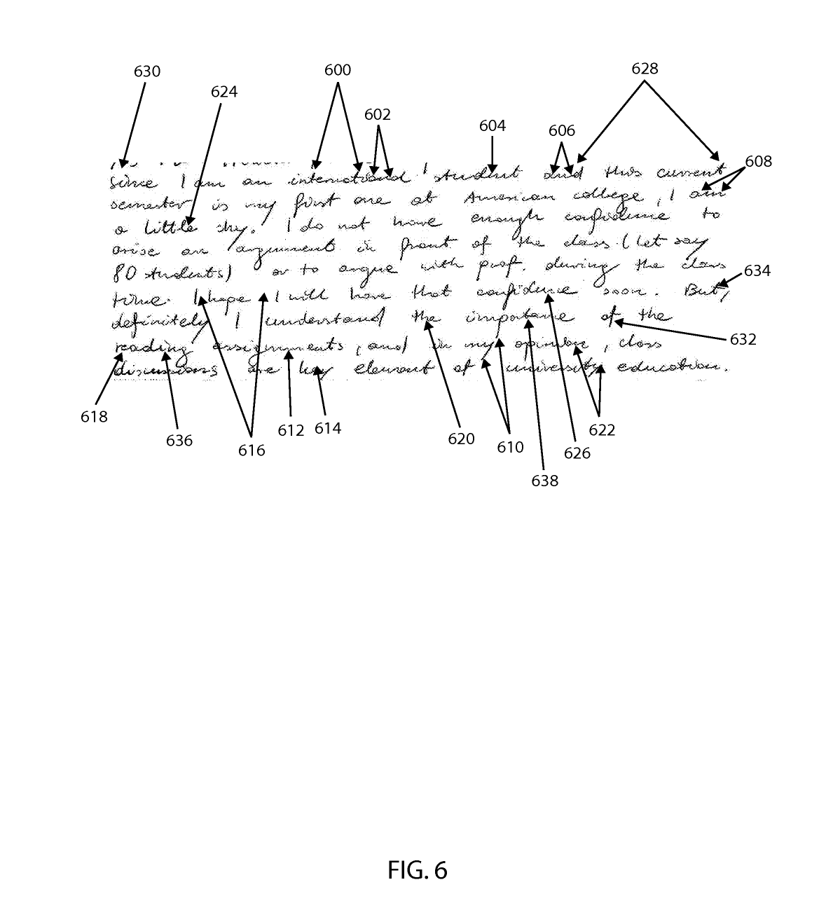

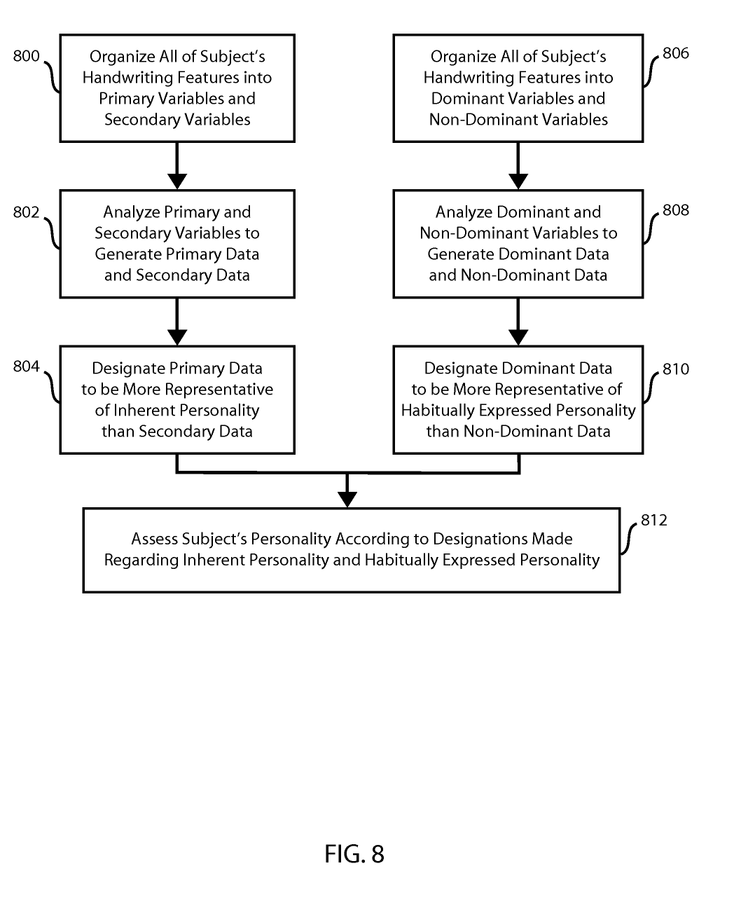

FIG. 6 is a handwriting sample produced by a subject for analysis of the subject's personality in accordance with an embodiment of the invention. The handwriting sample of the subject includes instances of: developed upper zone 600 and developed middle zone 602; garlands 604; angles 606; arcades 608; dominant lower zone 610; dominant threaded handwriting 612; wide letters 614; words fluctuating in size between wide and narrow 616; narrow lines 618; vertical slant 620; extreme rightward slant 622; leftward tendencies (such as compression; retracing; and rigidness) 624; rightward tendencies (including slight loss of legibility) 626; tent-like structures in letters “t” and “d” 628; connected i-dots 630; t-bar crossings to the right of the t-stem 632; strong t-bar crossings 634; FIG. 8 “g” formations appearing as part of “ing” portion of word 636; and dominant rightward slant 638.

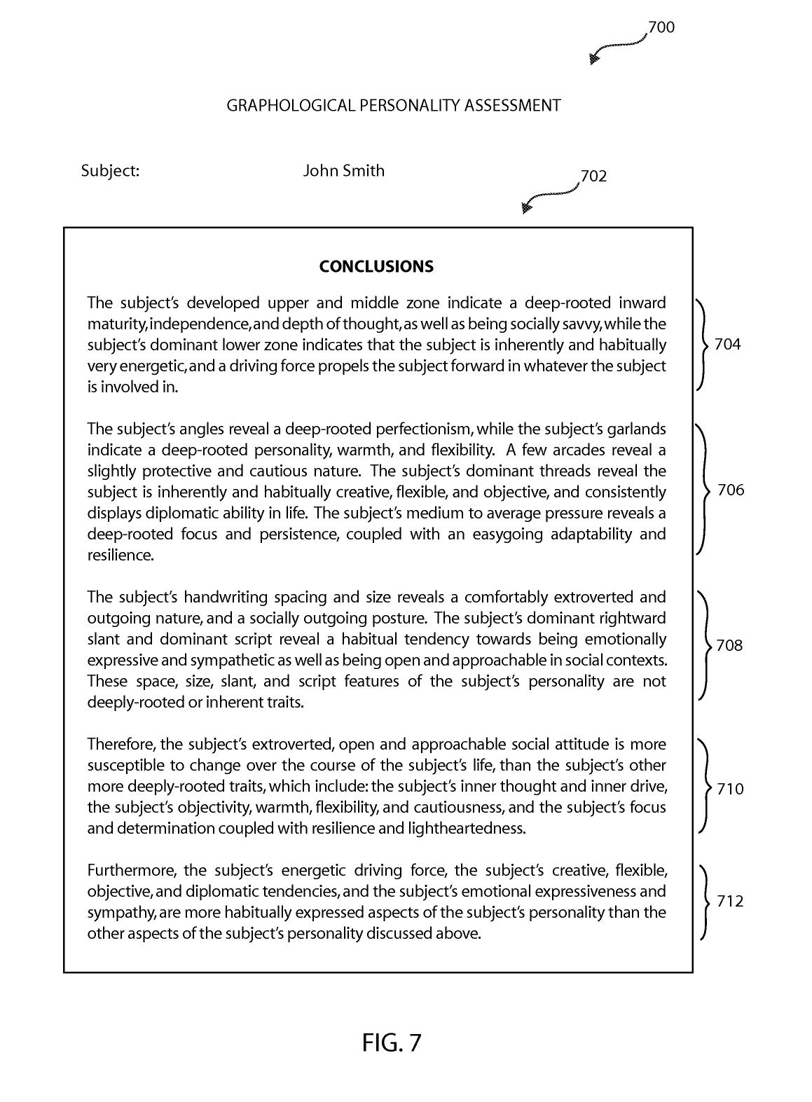

FIG. 7 is an example graphological personality assessment conclusions section, which summarizes conclusions made in accordance with an embodiment of the invention. A first paragraph discusses aspects of the subject's more inherent personality exhibited by the primary variables of zonal sizes, including a dominant lower zone.

A second paragraph discusses aspects of the subject's more inherent personality exhibited by the primary variables of connective forms and handwriting pressure, including dominant threaded language. The third paragraph discusses aspects of the subject's less inherent (and more susceptible to change) personality exhibited by the secondary variables of handwriting spacing, size, slant, and level of script, including a dominant rightward slant and dominant script.

The fourth paragraph separates the more inherent personality traits exhibited by primary variables, from the less inherent (and more changeable) personality traits exhibited by secondary variables. Finally, the fifth paragraph separates the more habitually expressed personality traits exhibited by dominant variables, from the less habitually expressed (and inconsistent) personality traits exhibited by non-dominant variables.

In reference to paragraph 704, all zonal features are primary variables, and therefore they are all indicative of more inherent aspects of the subject's personality. The subject exhibits a developed upper and middle zone, with a dominant lower zone. The developed upper zone reveals that the writer is inwardly mature, independent, and a deep thinker, while the developed middle zone also reveals that the subject is socially directed and is savvy to trends and fashion.

Not only does the subject's lower zone reveal information about their more inherent and deep-rooted personality, as does all zonal information, but the fact that this feature is expressed dominantly means that the information it reveals is part of the subject's habitual, consistent, and regular personality. The subject's dominant lower zone reveals that the subject is habitually and regularly very energetic and can work long and productive hours to finish projects. Because the subject's lower zone is expressed dominantly, it can be interpreted as an almost ever-present driving force which energizes the subject and keeps the subject going.

Therefore, even if the subject may at times engage in mental activity that is not typical of developed upper and middle zones, the energetic driving force indicated in their dominant lower zone will still remain regularly available to them. As such, it will provide energy, drive, and momentum for whatever the subject happens to turn his or her focus towards, be it upper and/or middle zone interests, or other interests.

In reference to paragraph 706, connective forms are primary variables, and therefore they are indicative of more inherent aspects of the subject's personality. In analyzing a subject's connective forms, it is important to note that aspects of a subject's personality revealed through connective forms typically can be interpreted in a positive or negative light, depending on the form level of the subject's handwriting.

The present subject exhibits good overall form, and therefore the inherent aspects of the subject's personality revealed by their connective forms are to be given a more positive interpretation.

All of these handwriting features are connective forms, which are also primary variables, and therefore they are all indicative of the subject's more inherent and deep-rooted personality. They are to be interpreted in a relatively positive light due to the subject's good form level.

The subject exhibits some garlands and angles, and a few arcades, while the subject's handwriting is also dominantly threaded. The subject's angles reveal a focus and a considerable level of perfectionism, while the garlands indicate personality, warmth, flexibility, and a generally easygoing nature. These two handwriting features thus reveal a deeply-rooted inner balance to the subject's personality.

The few arcades reveal a slightly protective, sensitive, reserved, and cautious nature, which will surface occasionally, depending upon the subject's mood. On the other hand, the subject's dominant threads reveal that the subject is habitually creative, flexible, and objective, and consistently displays diplomatic ability. In view of the foregoing, the subject contains the following deep-rooted personality traits: habitually and very often creative, flexible, objective, and diplomatic; relatively frequently focused and perfectionist, while at the same time warm, flexible, and easygoing; and intermittently slightly cautious, protective, reserved and sensitive in nature, depending upon the situation and the subject's mood. Pressure is a primary variable, and therefore indicates more inherent aspects of the subject's personality. The subject exhibits medium and average pressure. This supports the above mentioned complimentary mix between being focused, determined and persistent, while at the same time being easygoing, adaptable and resilient.

Thus the subject can accomplish tasks and approach goals in a focused and determined manner, but also can maintain an easygoing outlook which translates into less overall stress even while successfully working towards and completing projects.

Furthermore, any pressure pattern of at least medium pressure reveals a considerable driving force, which in this case is consistent with the current subject's dominant lower zone energy.

Nonetheless, the pressure pattern is slightly inconsistent, thereby revealing a slight inconsistency in the subject's ability to focus at times due to such effects as anxiety, fear, and/or depression.

Given the subject's high form level, the subject can be expected to recognize when a break or vacation is required, so as to relax and/or re-energize and come back strong.

In reference to paragraph 708, letter spacing features are secondary variables, and therefore they are indicative of less inherent aspects of the subject's personality than are primary variables. This subject exhibits wide letter spacing, fluctuating word spacing, and narrow line spacing.

The wide letter spacing reveals a comfortably extroverted and outgoing nature, and the narrow line spacing reveals that the writer is comfortably active in life, taking on many activities.

The fluctuating word spacing reveals that the writer can fluctuate between being warm, caring, and responsive to others (narrow), but also can be cold, distant, and emotionally withdrawn from others as well (wide), depending on the subject's mood.

The subject's handwriting size (8 mm in height) is medium and average, which indicates that in direct social interactions the subject can exhibit a complementary mix between socially outgoing, extroverted and generous, while at the same time independent, objective, and focused.

This medium and average overall size handwriting therefore supports the findings discussed in connection with the subject's spacing (above).

The subject exhibits a dominant rightward slant, including some extremely rightward-leaning letters as well as somewhat vertically-oriented lettering. The slant is interpreted in a relatively positive light, given the subject's generally good form level.

While the vertical lettering indicate independence, objectivity and neutrality, the extremely rightward slanted letters indicate the subject's emotions can sabotage their objectivity in some cases.

The dominant rightward slant reveals a habitual pattern of extroversion, passion, and strong emotional expression in social contexts. The fact that this rightward slant is dominantly expressed, indicates that the subject will tend to be more emotionally expressive, sympathetic, and extroverted, than cold, distant or withdrawn.

Therefore, even though the fluctuating word spacing indicated that the subject may at times be withdrawn or otherwise exhibit coldness and distance, this kind of emotional withdrawal will be exhibited far less than the subject's more habitual tendency towards emotional expressiveness and social connectedness.

The subject's level of script is expressed dominantly, as evidenced by the subject's handwriting almost entirely in cursive. This dominant script indicates a habitual openness and approachability, which fits well with the earlier conclusions that the writer tends to be extroverted, emotionally involved, and socially aware.

The subject's extroverted, open, and approachable social attitude is more susceptible to change over the course of the subject's life, than the subject's other more deeply-rooted traits, which include: the subject's inner thought and inner drive, the subject's objectivity, warmth, flexibility, and cautiousness, and the subject's focus and determination coupled with resilience and lightheartedness. Furthermore, the subject's energetic driving force, the subject's creative, flexible, objective, and diplomatic tendencies, and the subject's emotional expressiveness and sympathy, are more habitually expressed aspects of the subject's personality than the other aspects of the subject's personality discussed above.

FIG. 8 is a flowchart detailing the steps taken by a graphologist in assessing a subject's personality in accordance with an embodiment of the invention.

On the one hand, all handwriting features of a subject's handwriting sample are organized into primary variables and secondary variables, which are analyzed to generate primary data and secondary data. The primary data is then designated to be more representative of inherent personality than secondary data.

All of the subject's handwriting features are also organized into dominant variables and non-dominant variables, which are analyzed to generate dominant data and non-dominant data. The dominant data is designated to be more representative of habitually expressed personality than non-dominant variables.

In preferred embodiments, all handwriting features are organized into dominant primary variables, non-dominant primary variables, dominant secondary variables, and non-dominant secondary variables, which are then analyzed to generate primary data, secondary data, dominant data, and non-dominant data.

All primary data is designated to be more representative of inherent personality than secondary data, and all dominant data is designated to be more representative of habitually expressed personality than non-dominant variables.

Finally, the subject's personality is assessed according to the designations made regarding inherent personality and habitually expressed personality.

Other modifications and implementations will occur to those skilled in the art without departing from the spirit and the scope of the invention as claimed.

Accordingly, the above description is not intended to limit the invention except as indicated in the following claims.

1. A method for enhanced graphological assessment of personality traits of a subject using categorization of handwriting features, the method comprising:
(a) organizing handwriting features of a subject's handwriting sample into two sets, the two sets including:
(i) a set of primary variables,
the primary variables being handwriting features presumed to represent an individual's deep-rooted personality traits; and
(ii) a set of secondary variables,
the secondary variables being handwriting features presumed to not represent an individual's deep-rooted personality traits;
(b) analyzing the primary variables and secondary variables so as to generate primary data and secondary data;
(c) organizing the handwriting features of a subject's handwriting sample into two other sets, the two other sets including:
(i) a set of dominant variables,
the dominant variables being handwriting features expressed strongly in the handwriting sample, and therefore presumed to represent the subject's dominant traits; and
(ii) a set of non-dominant variables,
the non-dominant variables being handwriting features not expressed strongly in the handwriting sample, and therefore presumed to represent the subject's non-dominant traits;
(d) analyzing the dominant variables and non-dominant variables so as to generate dominant data and non-dominant data; and
(e) assessing the subject's personality traits by:
(i) designating primary data as more representative of the subject's inherent personality than secondary data; and
(ii) designating dominant data as more representative of the subject's habitual personality than non-dominant data.

2. The method of claim 1, wherein a secondary variable is designated as representing aspects of the subject's personality that are more changeable than aspects of the subject's personality represented by primary variables.

3. The method of claim 1, wherein a non-dominant variable is designated as representing aspects of the subject's personality that are expressed less consistently than aspects of the subject's personality represented by dominant variables.

4. The method of claim 1, wherein the primary variables include at least one of:
relative zonal sizes of the handwriting;
use of connective forms; and
level of pressure applied during the handwriting.

5. The method of claim 4, wherein the relative zonal sizes include:
an upper zonal size;
a middle zonal size; and
a lower zonal size;

6. The method of claim 4, wherein the connective forms include at least one of:
garlands;
arcades;
angles;
threads; and
a combination of at least two of garlands, arcades, angles, and threads.

7. The method of claim 4, wherein the level of pressure applied during the handwriting is one of:
light pressure;
medium pressure;
heavy pressure; and
a combination of at least two of light pressure, medium pressure, and heavy pressure.

8. The method of claim 1, wherein the secondary variables include at least one of:
distribution of spacing in the handwriting;
size of the handwriting;
slant of the handwriting;
level of script of the handwriting; and
character formations, the character formations including any specific type of letter formation in the handwriting.

9. The method of claim 8, wherein distribution of spacing includes:
distribution of space within margins;
distribution of space between letters;
distribution of space between words; and
distribution of space between lines.

10. The method of claim 1, further comprising:
(f) applying a form level analysis to the handwriting, the form level analysis indicating social healthiness of the subject's personality, thereby enhancing interpretation of the subject's handwriting features so as to aid in determining the subject's personality traits.

11. The method of claim 10, wherein the form level analysis includes analysis of at least one of:
symmetry in the handwriting;
handwriting speed;
creativity in the handwriting; and
handwriting rhythm.

12. A method for enhanced graphological assessment of personality traits of a subject using categorization of handwriting features, the method comprising:
(a) applying a form level analysis to the handwriting, the form level analysis indicating social healthiness of the subject's personality;
(b) organizing handwriting features of a subject's handwriting sample into two sets, the two sets including:
(i) a set of primary variables,
the primary variables being handwriting features categorically presumed to represent an individual's deep-rooted personality traits; and
(ii) a set of secondary variables,
the secondary variables being handwriting features categorically presumed to not represent an individual's deep-rooted personality traits;
(c) analyzing the primary variables and secondary variables so as to generate primary data and secondary data;
(d) organizing the handwriting features of a subject's handwriting sample into two other sets, the two other sets including:
(i) a set of dominant variables,
the dominant variables being handwriting features expressed strongly in the handwriting sample, and therefore presumed to represent the subject's dominant traits; and
(ii) a set of non-dominant variables, the non-dominant variables being handwriting features not expressed strongly in the handwriting sample, and therefore presumed to represent the subject's non-dominant traits;
(e) analyzing the dominant variables and non-dominant variables so as to generate dominant data and non-dominant data; and
(f) assessing the subject's personality traits by:
(i) interpreting at least one of the primary data, secondary data, dominant data, and non-dominant data in light of conclusions derived from the form level analysis of the handwriting, thereby enhancing interpretation of the subject's handwriting features so as to aid in determining the subject's personality traits;
(ii) designating primary data as representative of the subject's more inherent personality and secondary data as representative of the subject's more changeable personality; and
(iii) designating dominant data as representative of the subject's more habitual personality and non-dominant data as representative of the subject's more inconsistently expressed personality.

13. The method of claim 1, wherein the primary variables include at least one of:
relative zonal sizes of the handwriting;
use of connective forms; and
level of pressure applied during the handwriting.

14. The method of claim 13, wherein the relative zonal sizes include:
an upper zonal size;
a middle zonal size; and
a lower zonal size;

15. The method of claim 13, wherein the connective forms include at least one of:
garlands;
arcades;
angles;
threads; and
a combination of at least two of garlands, arcades, angles, and threads.

16. The method of claim 13, wherein the level of pressure applied during the handwriting is one of:
light pressure;
medium pressure;
heavy pressure; and
a combination of at least two of light pressure, medium pressure, and heavy pressure.

17. The method of claim 1, wherein the secondary variables include at least one of:
distribution of spacing in the handwriting,
size of the handwriting;
slant of the handwriting;
level of script of the handwriting; and
character formations, the character formations including any specific type of letter formation in the handwriting.

18. The method of claim 17, wherein distribution of spacing includes:
distribution of space within margins;
distribution of space between letters;
distribution of space between words; and
distribution of space between lines.

19. The method of claim 11, wherein the form level analysis includes analysis of at least one of:
symmetry in the handwriting;
handwriting speed;
creativity in the handwriting; and
handwriting rhythm.
